(19) United States
(12) Patent Application Publication
(10) Pub. No.: US 2011/0147537 A1
(43) Pub. Date: Jun. 23, 2011

(54) Light String Hanging Apparatus

(76) Inventor: Homer Leon Ringo, JR., Conroe, TX (US)

(21) Appl. No.: 12/646,285

(22) Filed: Dec. 23, 2009

(51) Int. Cl. F16L 3/06

(52) U.S. Cl. 248/58

(57) ABSTRACT

A light string hanger is provided which may be mounted on a building structure without nails or fasteners. The light string hanger includes a body plate having connection points for releasably securing a light string and a support wall extending downwardly from the body plate. In order to mount the light string hanger on the building structure, an edge of the body plate is releasably secured to the roof edge, and the support wall is counter-balanced against a wall of the building structure. Alternatively, the light string hanger is designed to be mounted on a building structure having a gutter along a roof edge. In this case, the light string hanger includes first and second support walls extending downwardly from a same surface of a body plate, and arranged to form a clip. The light string hanger is mounted by resting the clip over an exterior wall of the gutter.

### BACKGROUND OF INVENTION

1. Technical Field

The invention relates generally to the subject of light string hangers, and, in particular, to devices which quickly hang and neatly store strings of decorative light bulbs.

2. Background Art

Strings of light bulbs, or light strings, are commonly used to decorate homes and businesses for special occasions, including family events and, in particular, holiday seasons. Methods and systems for mounting light strings along a roof edge of a building structure are well known in the art. Typically, such systems include a set of removable hooks, which may be mounted on the building structure along the roof edge for supporting a series of decorative lights disposed along the light string. Generally, the removable hooks are attached to the building structure using fasteners such as nails or staples. Once the removable hooks have been mounted, light strings may be hung on the hooks to provide a pleasing appearance to the building for the duration of a holiday season. Once the holiday season has passed, it becomes desirable to restore the building to its original appearance. Accordingly, any light strings and removable hooks that have been hung are taken down and stored for the next holiday season.

Although such decorative lighting is attractive, the process of mounting and removing the light strings can be a time-consuming and often dangerous task. The removable hooks must be mounted one-by-one, which requires the person hanging the lights to move a ladder each time he/she adds a hook to the building. As each decorative light is hung on a hook, the remainder of the light string hangs down the side of the building, and could easily get tangled in the ladder or be mishandled by a child or pet. Tension in the hanging portion of the light string may cause damage to its electrical wiring. Further, homeowners are often impatient when removing the light string, and tend to yank the light string off of the hooks rather than remove it properly. This may cause further tension in, and hence damage to, the electrical wiring and damage to the decorative light bulbs. What remains of the light string is then often stored in a haphazard and tangled manner. In addition, the detachment of the nails used to mount the hooks leaves unsightly damage to or holes in the building structure, which may lower a monetary value of the home or business. Alternatively, the nails, or fasteners, remain affixed to the building structure, which may also result in an unsightly appearance.

Accordingly, it would be desirable to provide a light string hanger that may be balanced along a roof edge of a building structure. In such a scheme, the light string hanger may be mounted on the building without the use of nails or fasteners. Advantageously, an amount of time required to mount and remove the light string hanger may be decreased, thereby increasing an efficiency of the decorative light hanging process. In addition, unsightly damage to the building structure may be minimized, thereby ensuring that a monetary value of the building is not decreased.

It would also be desirable to provide a light string hanging system in which a light string may be attached to a set of light string hangers before mounting on a building structure. Accordingly, an amount of time and an amount of effort required to hang the light string may be decreased. In addition, tension in the light string from the hanging process may be minimized, thereby minimizing damage to the electrical wiring. Further, the light string hanger may be dismounted from the building without removing the light string from the light string hanger, also minimizing damage. In addition, the light string may remain fastened to the light string hanger during nonuse, and, advantageously, stored in a neat and untangled manner. When unpacked from storage for the next holiday season, the light string would not have to be refastened to the light string hanger, further increasing an efficiency of the light string hanging process.

### SUMMARY OF INVENTION

According to one aspect, an apparatus for hanging a light string includes a body plate; a support wall disposed between first and second opposing edges of the body plate and extending downwardly from a surface of the body plate; a plurality of connection points for releasably securing the light string disposed on the body plate between the support wall and the first edge; and a drip wall disposed along the first edge of the body plate and extending downwardly from the first edge.

According to another aspect, an apparatus for hanging a light string includes a body plate; first and second support walls extending downwardly from the body plate and arranged to form a clip; a plurality of connection points disposed on the body plate between the first support wall and a first edge of the body plate, each connection point arranged to secure a hanging light of the light string; and a drip wall extending downwardly from the first edge of the body plate at an acute angle to a surface of the body plate.

According to another aspect, a method for mounting a light string on a building structure includes releasably securing the light string to a body plate of a light string hanger, each hanging light of the light string fastened to a connection point disposed on the body plate between a first edge of the body plate and a support wall extending downward from the body plate; releasably securing an opposing second edge of the body plate along a roof edge of the building structure; and resting the support wall against an exterior wall of the building structure.

Other aspects and advantages of the invention will be apparent from the following description and the appended claims.

### BRIEF DESCRIPTION OF DRAWINGS

FIG. 1 shows a perspective view of a light string hanger in accordance with a first embodiment of the present invention.

FIG. 2 shows a perspective view of a light string hanger in accordance with a second embodiment of the present invention.

FIGS. 3a and 3b show views of a light string hanger having a light string attached in accordance with an embodiment of the present invention.

FIG. 4 shows a cross sectional view of a light string hanger mounted on a building structure in accordance with the first embodiment.

FIG. 5 shows a cross sectional view of a light string hanger mounted on a building structure in accordance with the second embodiment.

### DETAILED DESCRIPTION

Embodiments of the present invention will now be described with reference to the above drawings. Like references are used in the figures to represent like elements.

Embodiments of the present invention relate to a method and apparatus for hanging a light string on a building structure. Embodiments of the present invention further relate to a light string hanging apparatus, referred to herein as a light string hanger, which may be mounted on a building structure by being balanced along a roof edge of the structure. In one embodiment, the light string hanger is provided with a body plate having connection points for releasably securing a light string and a support wall extending downwardly from the body plate. In order to mount the light string hanger on the building structure, an edge of the body plate is releasably secured to the roof edge, and the support wall is counter-balanced against a wall of the building structure. In an alternate embodiment, a light string hanger is designed to be mounted on a building structure having a gutter disposed along a roof edge. The light string hanger provided with first and second support walls extending downwardly from a same surface of a body plate, and arranged to form a clip. In order to mount the light string hanger, the first and second support walls are clipped over the gutter.

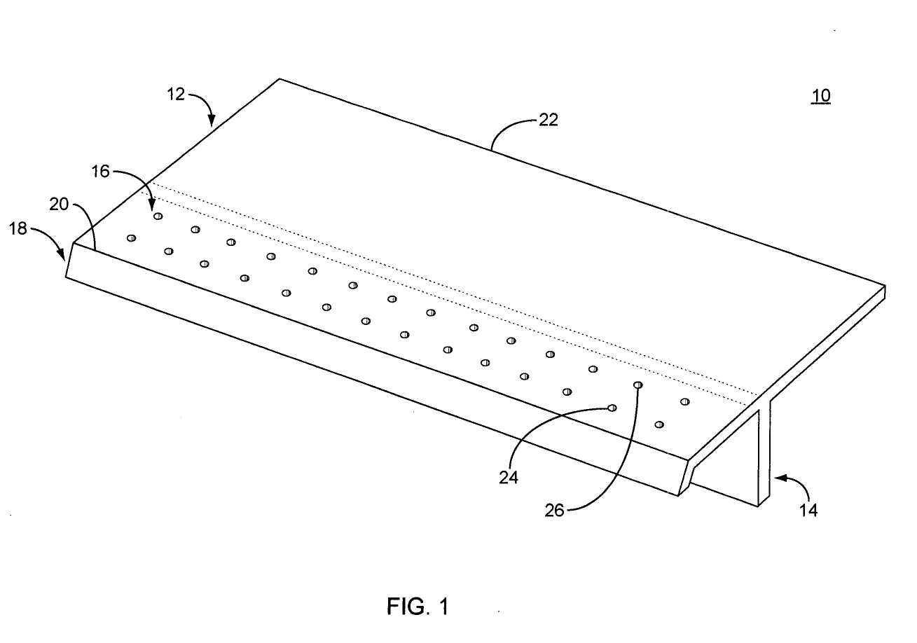

FIG. 1 shows a perspective view of a light string hanger (10) in accordance with a first embodiment of the invention. The light string hanger (10) includes a body plate (12), a support wall (14), connection points (16) for releasably securing a light string (not shown), and a drip wall (18). The support wall (14) is disposed between first and second opposing edges (20, 22) of the body plate (12) and extends downwardly from a surface of the body plate (12). An edge of the support wall (14) connected to the body plate (12) is substantially parallel to the first and second edges (20, 22). In addition, the support wall (14) extends from the body plate (12) in a direction substantially perpendicular to the surface of the body plate (12). Further, the drip wall (18) extends from the first edge (20) at an acute angle downward from the body plate (12). The body plate (12), the support wall (14), and the drip wall (18) are of a substantially similar length.

The connection points (16) are disposed on the body plate (12) between the first edge (20) and the support wall (14). As shown, each connection point (16) includes a pair of apertures (24, 26) extending through the body plate (12) to which a fastener (not shown) for securing a portion of a light string may be releasably attached. Those skilled in the art will appreciate that, although each connection point (16) is shown as a pair of apertures (24, 26), alternatively, each connection point (16) may be formed as a single element. Further, in some embodiments, the light string hanger (10) may be formed of a lightweight, sturdy material such as plastic.

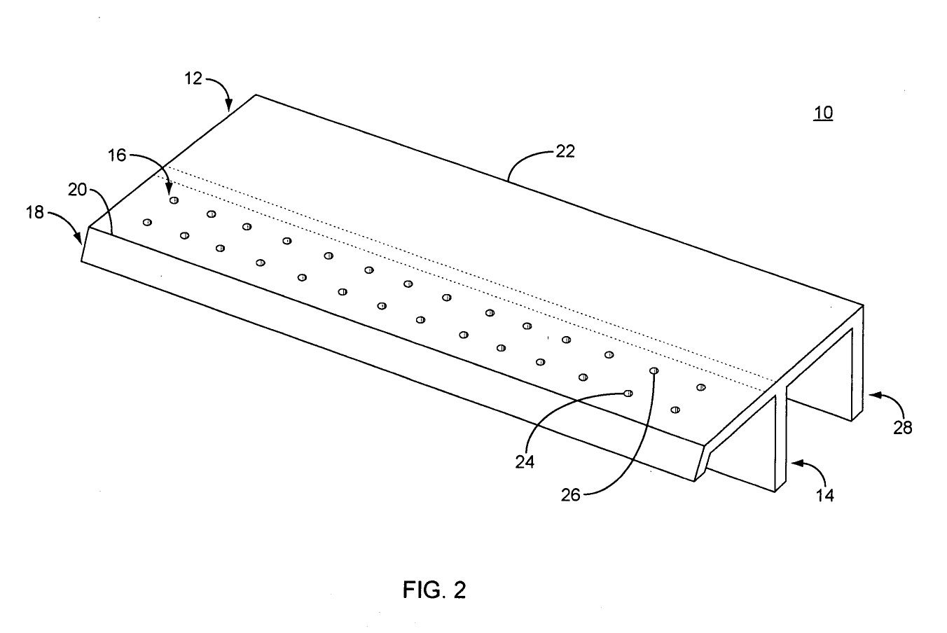

FIG. 2 shows a perspective view of a light string hanger (10) in accordance with a second embodiment of the invention. The light string hanger (10) includes a body plate (12), connection points (16), a drip wall (18), and first and second support walls (14, 28). The first support wall (14) is disposed between first and second edges (20, 22) of the body plate (12) and extends downwardly from a surface of the body plate (12). The second support wall (28) extends downwardly from the second edge (22) of the body plate (12). Both the first and second support walls (14, 28) extend from the body plate (12) in a direction substantially perpendicular to the surface of the body plate (12). Together, the first and second support walls (14, 28) form a clip that may be used for mounting the light string hanger (10). Further, the drip wall (18) extends from the first edge (20) at an acute angle downward from the body plate (12). The body plate (12), the first and second support walls (14, 28), and the drip wall (18) are of a substantially similar length.

The connection points (16) are disposed on the body plate (12) between the first edge (20) and the support wall (14). Each connection point (16) includes first and second apertures (24, 26) extending through the body plate (12) to which a fastener for securing a portion of a light string may be releasably attached. Those skilled in the art will appreciate that, although each connection point (16) is shown as a pair of apertures (24, 26), alternatively, each connection point (16) may be formed as a single element.

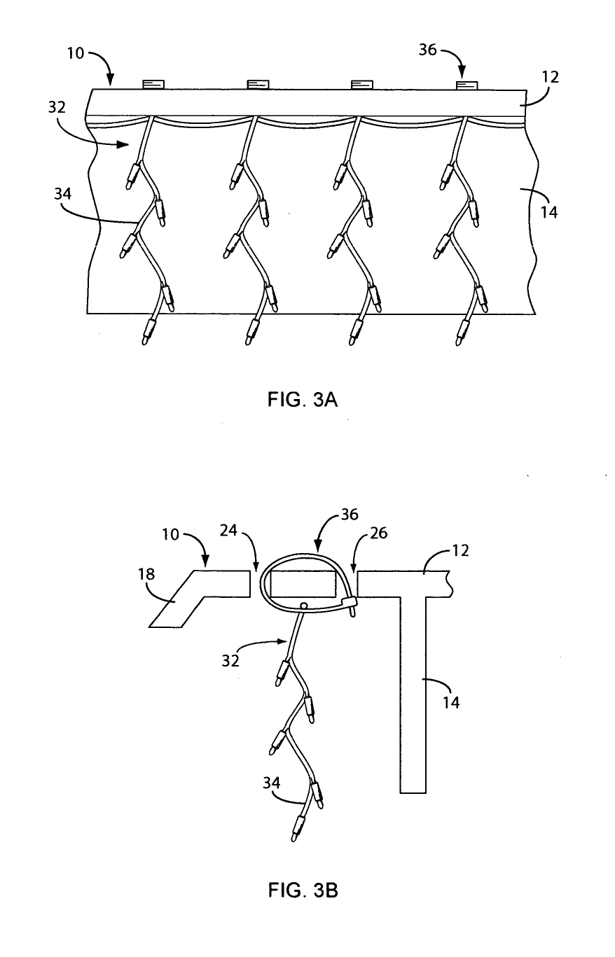

FIGS. 3A and 3B show exemplary views of the light string hanger (10) having a light string (32) attached. FIG. 3A shows a front view of the light string hanger (10) and light string (32), and FIG. 3B shows a cross sectional view. Note that, in FIG. 3A, the drip wall (18) is not shown in order to aid in the understanding of the invention. For the views shown, the light string (32) is of an icicle type. Those skilled in the art will appreciate that the light string hanger (10) may also be used to hang other types of light strings, such as C-7, C-9, and LED.

Referring to FIGS. 3A and 3B, a light string (32) having a series of hanging lights (34) is releasably secured to the light string hanger (10). Each hanging light (34) is attached to the light string hanger (10) using a fastener (36) releasably secured to the body plate (12). As shown in FIG. 3B, the fastener (36) is secured to the body plate (12) through the first and second apertures (24, 26) of a connection point (16). In some embodiments, the fastener (36) may be a cable tie. Those skilled in the art will appreciate that, although the fastener (36) is shown as separate from the light string hanger (10), alternatively, the fastener (36) and the connection point (16) may be formed as a single element.

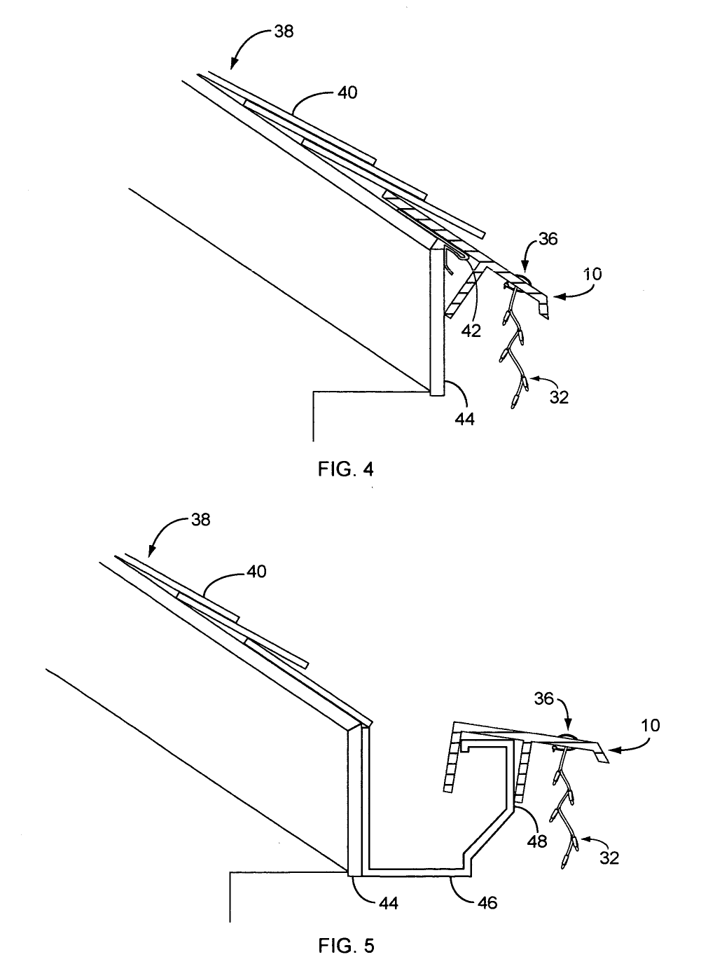

FIG. 4 shows a cross sectional view of the light string hanger (10) mounted along a roof edge of a building structure (38) in accordance with the first embodiment. The roof edge includes shingles (40) and a drip edge (42). In order to mount the light string hanger (10), the second edge (22) of the body plate (12) is inserted between the shingles (40) and the drip edge (42), and the support wall (14) is rested against a fascia wall (44) of the building structure (38). Thus, the support wall (14) acts as a counter-balance for the weight of the light string hanger (10) and light string (32), thereby allowing the light string hanger (10) to be balanced along the roof edge of the building structure (38). Accordingly, the light string hanger (10) may be secured to the building structure (38) without the use of fasteners such as nails.

FIG. 5 shows a cross sectional view of the light string hanger (10) mounted along a roof edge of a building structure (38) in accordance with the second embodiment. As shown, the roof edge includes a gutter (46) having an exterior wall (48). In order to mount the light string hanger (10), the second support wall (28) is clipped over an upper edge of the exterior wall (48), and the first support wall (14) is counter-balanced against an exterior surface of the exterior wall (48). Accordingly, the light string hanger (10) may be secured to the gutter (46) of the building structure (38) without the use of fasteners.

Referring to FIGS. 4 and 5, because the light string hanger (10) may be mounted on the building structure (38) without the use of fasteners, an amount of time required to mount and remove the light string hanger (10) is decreased. Advantageously, an amount of time and an amount of effort required to hang the light string (32) is decreased, thereby increasing an efficiency of the light string hanging process. In addition, unsightly damage to the building structure (38) is minimized, thereby ensuring that a monetary value of the building structure (38) is not decreased.

Referring to FIGS. 1, 2, 4, and 5, note that unsightly damage to the building structure (38) is also minimized by the inclusion of the drip wall (18) along the first edge (20) the light string hanger (10). For the embodiment shown in FIG. 4, the drip wall (18) performs the function of the building structure's (38) drip edge (42), which is covered by the light string hanger (10). Advantageously, due to the inclusion of the drip wall (18), water and debris may still be prevented from damaging the building structure (38). For the embodiment shown in FIG. 5, the drip wall (18) performs the function of the building structure's (38) gutter (46) by preventing water and debris from running down the building structure (38).

With reference to FIGS. 1, 2, 4, and 5, an entire light string (32) may attached to a group of light string hangers (10) before the light string hangers (10) are mounted on the building structure (38). Accordingly, a tension in the light string (32) from a hanging process may be minimized. Once the light string (32) has been attached to the light string hangers (10), the light string (32) may be folded so that the light string hangers (10) sit on top of one another. A person hanging the light string (32) may then climb a ladder with the entire light string (32) and quickly hang the light string (32) by inserting or clipping the light string hanger (10) in or to the roof edge of the building structure (38) as described for FIGS. 4 and 5. Advantageously, the amount of time and effort required to hang the light string (32) may be further decreased. Note that each light string hanger (10) may be cut to size in order to accommodate a length of the light string (32).

In addition, the light string hanger (10) may be dismounted from the building structure (38) without removing the light string (32) from the light string hanger (10). To dismount the light string (32), each light string hanger (10) that the light string (32) is attached to is pulled off of the building structure (38) and folded over on top of the previously dismounted light string hanger (10). In this manner, damage to wiring and the hanging lights (34) of the light string (32) is minimized. Also, the light string (32) may remain fastened to the light string hangers (10) during nonuse, and, advantageously, stored in a neat and untangled manner. Because the light string (32) may remain fastened to the light string hangers (10) during storage, the light string (32) does not have to be refastened to the light string hangers (10) when unpacked for remounting on the building structure (38). Advantageously, the amount of time required to hang the light string (32) on the building structure (38) is further reduced, which, in turn, further increases the efficiency of the light string hanging process.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for hanging a light string, comprising:
a body plate;
a support wall disposed between first and second opposing edges of the body plate and extending downwardly from a surface of the body plate;
a plurality of connection points for releasably securing the light string disposed on the body plate between the support wall and the first edge; and
a drip wall disposed along the first edge of the body plate and extending downwardly from the first edge.

2. The apparatus of claim 1, wherein the drip wall extends from the first edge at an acute angle to the surface of the body plate.

3. The apparatus of claim 1, wherein each connection point of the plurality of connection points comprises first and second apertures extending through the body plate and arranged to receive a fastener for securing a hanging light of the light string.

4. The apparatus of claim 1, wherein the apparatus is mounted along a roof edge of a building structure by inserting the second edge of the body plate between a drip edge of the roof edge and shingles of the roof edge, and resting the support wall against a wall of the building structure.

5. The apparatus of claim 1, wherein an edge of the support wall connected to the surface of the body plate is substantially parallel to the first and second edges of the body plate, and the support wall extends from the body plate at an angle substantially perpendicular to the surface of the body plate.

6. The apparatus of claim 1, wherein the body plate, the support wall, and the drip wall are of a substantially similar length.

7. The apparatus of claim 1, wherein the apparatus is formed of a sturdy, lightweight material.

8. An apparatus for hanging a light string, comprising:
a body plate;
first and second support walls extending downwardly from the body plate and arranged to form a clip for mounting the light string hanger;
a plurality of connection points disposed on the body plate between the first support wall and a first edge of the body plate, each connection point arranged to secure a hanging light of the light string; and
a drip wall extending downwardly from the first edge of the body plate at an acute angle to a surface of the body plate.

9. The apparatus of claim 8, wherein the first support wall is disposed between the first edge and an opposing second edge of the body plate, and the second support wall extends from the second edge of the body plate.

10. The apparatus of claim 9, wherein an edge of the first support wall is connected to a surface of the body plate, and wherein the edge of the first support wall is substantially parallel to the first and second edges of the body plate.

11. The apparatus of claim 8, wherein the first and second support walls extend from the body plate at an angle substantially perpendicular to a surface of the body plate.

12. The apparatus of claim 8, wherein each connection point comprises first and second apertures extending through the body plate and arranged to receive a fastener for securing the hanging light of the light string.

13. The apparatus of claim 8, wherein the apparatus is mounted along a roof edge of a building structure by clipping the second support wall over an upper edge of an exterior wall of a gutter of the roof edge, and resting the first support wall against an exterior surface of the exterior wall of the gutter.

14. The apparatus of claim 8, wherein the body plate, the first and second support walls, and the drip wall are of a substantially similar length.

15. The apparatus of claim 8, wherein the apparatus is formed of a sturdy, lightweight material.

16. A method for mounting a light string on a building structure, comprising:
releasably securing the light string to a body plate of a light string hanger, each hanging light of the light string fastened to a connection point disposed on the body plate between a first edge of the body plate and a support wall extending downwardly from the body plate;
releasably securing an opposing second edge of the body plate along a roof edge of the building structure; and
resting the support wall against an exterior wall of the building structure.

17. The method of claim 16, wherein the second edge of the body plate is releasably secured by inserting the second edge between a drip edge of the roof edge and shingles of the roof edge.

18. The method of claim 16, wherein a second support wall extends downward from the second edge of the body plate, and the second edge of the body plate is releasably secured by clipping the second support wall over a gutter of the roof edge.

19. The method of claim 16, wherein a drip wall extends downward from the first edge of the body plate.

20. The method of claim 16, wherein each connection point comprises apertures arranged to receive a fastener for securing the light string.
